(19) United States
(12) Patent Application Publication
(10) Pub. No.: US 2022/0269226 A1
(43) Pub. Date: Aug. 25, 2022

(54) CONTROL DEVICE FOR CONTROLLING A TECHNICAL SYSTEM, AND METHOD FOR CONFIGURING THE CONTROL DEVICE

(71) Applicant: Siemens Aktiengesellschaft, München (DE)

(72) Inventors: Daniel Hein, München (DE); Marc Christian Weber, München (DE); Holger Schöner, München (DE); Steffen Udluft, Eichenau (DE); Volkmar Sterzing, Neubiberg (DE); Kai Heesche, München (DE)

(21) Appl. No.: 17/674,123

(22) Filed: Feb. 17, 2022

(30) Foreign Application Priority Data
Feb. 24, 2021 (EP) 21158982.5

(51) Int. Cl. G05B 13/02

(52) U.S. Cl. CPC G05B 13/0265

(57) ABSTRACT

A control device for a technical system, state-specific safety information about an admissibility of a control action signal is read in by a safety module is provided. Furthermore, a state signal indicating a state of the technical system is supplied to a machine learning module and to the safety module. In addition, an output signal of the machine learning module is supplied to the safety module. The output signal is converted into an admissible control action signal by the safety module on the basis of the safety information depending on the state signal. Furthermore, a performance for control of the technical system by the admissible control action signal is ascertained, and the machine learning module is trained to optimize the performance. The control device is then configured by the trained machine learning module.

### CROSS-REFERENCE TO RELATED APPLICATIONS

This application claims priority to EP Application No. 21158982.5, having a filing date of Feb. 24, 2021, the entire contents of which are hereby incorporated by reference.

### FIELD OF TECHNOLOGY

The following relates to a control device for controlling a technical system, and method for configuring the control device.

### BACKGROUND

The control of complex technical systems, such as e.g., robots, production installations, gas turbines, wind turbines, internal combustion engines or power grids, increasingly involves the use of machine learning methods. Such learning methods can be used to train a machine learning model of a control device, by using training data, to take present operating signals of a technical system as a basis for ascertaining those control actions for controlling the technical system that specifically bring about a desired or optimized behavior of the technical system and hence optimize the performance of the technical system. Such a machine learning model for controlling a technical system is often also referred to as a policy or control model. A large number of known training methods, such as e.g., reinforcement learning methods, are available for training such a policy.

When using learning-based policies, there is often no guarantee, however, that the control actions that are output by the trained policy observe predefined limit values or other technical constraints in all situations. This is often a problem, particularly for safety-critical applications. It is known practice to avoid control errors by initially validating the control actions that are output by the trained policy and actuating the technical system using only validated control actions. A policy restricted in this manner does not act in an optimum fashion in many cases, however.

### SUMMARY

An aspect relates to a control device for controlling a technical system and a method for configuring the control device that allow control of the technical system to be improved.

To configure a control device for a technical system, safety information about an admissibility of a control action signal, which safety information is specific to a state of the technical system, is read in by a safety module. Furthermore, a state signal indicating a state of the technical system is supplied to a machine learning module and to the safety module. A signal will also be understood here and below to mean a data signal, in particular a numerical signal, that can encode floating point numbers or whole numbers, for example. The term state can also cover a state range. Furthermore, an output signal of the machine learning module is supplied to the safety module. The output signal is converted into an admissible control action signal by the safety module on the basis of the safety information depending on the state signal. In addition, a performance for control of the technical system by the admissible control action signal is ascertained, and the machine learning module is trained to optimize the performance. The control device is then configured on the basis of the trained machine learning module to control the technical system on the basis of an admissible control action signal that is output by the safety module.

To carry out the method according to embodiments of the invention, there is provision for a control device, a computer program product (non-transitory computer readable storage medium having instructions, which when executed by a processor, perform actions) and a non-volatile computer-readable storage medium.

The method according to embodiments of the invention and the control device according to embodiments of the invention can be for example embodied, or implemented, by one or more computers, processors, application-specific integrated circuits (ASIC), digital signal processors (DSP) and/or so-called “field programmable gate arrays” (FPGA).

Embodiments of the invention allow the machine learning module to be trained, in the learning phase already, to act in an optimized fashion in the face of safety-related modifications that the safety module has made for control action signals. Optimization will also be understood here and below to mean an approximation of an optimum. As such, both safety-compliant and optimized operation of a technical system controlled by the control device configured according to embodiments of the invention can be ensured in many cases. This allows the state-specific safety information to be used to easily take into consideration specific expert knowledge and/or domain knowledge during the training process.

According to an embodiment of the invention, a backpropagation method can be used for training the machine learning module. The method can involve a performance signal that quantifies the performance being backpropagated from an output of the safety module to an input of the safety module and a resulting performance signal furthermore being backpropagated from an output of the machine learning module to an input of the machine learning module. The backpropagation in this case can be performed through the safety module to a certain extent. Backpropagation is often also referred to as error backpropagation. In the present case, the performance signal can be backpropagated as an error signal, with the specific feature that a greater performance corresponds to a smaller error. Many efficient methods are known in the field of machine learning for carrying out backpropagation methods as such. Provided that it is possible to distinguish between mapping of input signals to output signals of the safety module and/or of the machine learning module, it is possible to use gradient-based backpropagation methods, e.g., gradient descent methods. For this purpose, a conversion performed by the safety module can be implemented as distinguishable mapping and, as such, can be gradient transmissive to a certain extent. The safety module can be implemented by a TensorFlow graph. Alternatively, or additionally, gradient-free backpropagation methods can also be used, such as e.g., genetic optimization methods.

According to a further advantageous embodiment, the safety module can use the safety information to examine whether the output signal is admissible as a control action signal. The output signal can then be converted on the basis of the examination result. The examination can be performed on the basis of a description of one or more safety criteria that indicate in particular limit values or constraints to be observed. Such a description may be coded or indicated in the safety information.

If the output signal is admissible as a control action signal, the output signal can be output by the safety module as an admissible control action signal. Otherwise, the output signal can be converted into the admissible control action signal. By way of example, it is possible to examine whether a limit value is observed, and to prompt a conversion only if this is not the case.

According to a further embodiment of the invention, the safety information can indicate or encode an admissible, state-specific default control action signal. The output signal can then be converted into the admissible default control action signal on the basis of the examination result. In this way, default actuation and/or a default behavior of the technical system can be ensured even in cases in which an advantageous or useful output signal is not generated, or that are only sparsely covered by training data.

According to a further embodiment of the invention, a volume of training data available for a state of the technical system that is specified by the state signal can be ascertained for this state. The examination for admissibility of the output signal can then be performed on the basis of the ascertained volume. A successful training of a machine learning model is fundamentally highly dependent on the available volume of training data. It must therefore generally be expected that the output signals of the machine learning module that are derived from a state that is only sparsely covered by training data will be afflicted by relatively great uncertainty. It therefore appears advantageous for output signals for states of the technical system that are only sparsely covered by training data to be rated as inadmissible.

Accordingly, a forecast error or modelling error of the machine learning module can be ascertained for a state specified by the state signal. The examination for admissibility of the output signal can then be performed on the basis of the ascertained forecast error or modelling error. In particular, output signals for states with a relatively large forecast or modelling error can be rated as inadmissible.

A measure of a volume of state-specific training data or of a state-specific forecast or modelling error can be ascertained in particular directly or by a variational autoencoder, a Bayesian neural network or by known cluster-based methods.

According to a further embodiment of the invention, the safety information can configure, indicate or encode a transformation function. The output signal and the state signal can be supplied to the transformation function. The output signal can then be converted into the admissible control action signal by the transformation function on the basis of the state signal.

Furthermore, the technical system can be controlled by the admissible control action signal, a behavior of the technical system controlled in this way being able to be detected. The performance can then be derived from the detected behavior. In this way, it is possible for e.g., a capacity or a yield of the technical system to be measured and output as a performance.

In addition, a behavior of the technical system controlled by the admissible control action signal can be simulated, predicted and/or read in from a database. The performance can then be derived from the simulated, predicted and/or read-in behavior.

### BRIEF DESCRIPTION

Some of the embodiments will be described in detail, with reference to the following figures, wherein like designations denote like members, wherein:

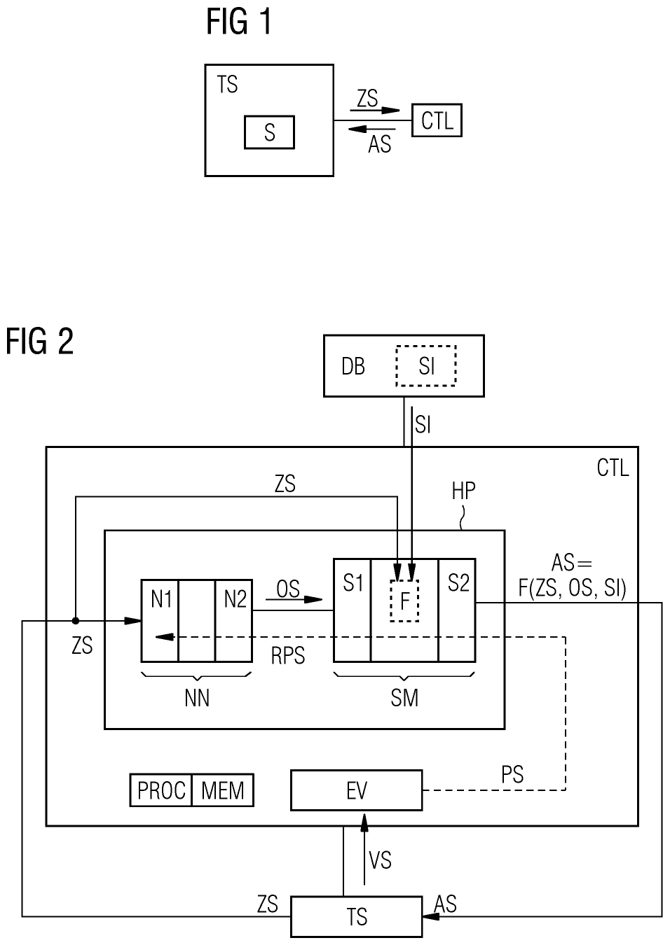

FIG. 1 shows a gas turbine with a control device according to embodiments of the invention,

FIG. 2 shows a control device according to embodiments of the invention in a training phase,

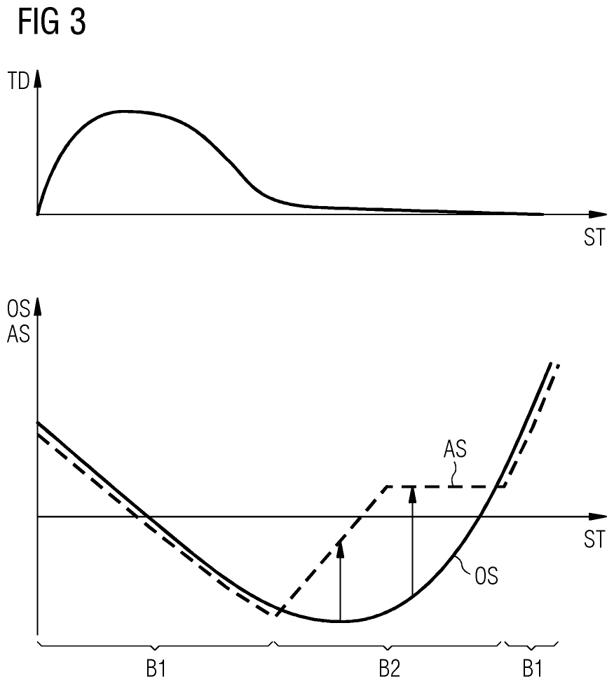

FIG. 3 shows a conversion of a raw control action signal into an admissible control action signal, and

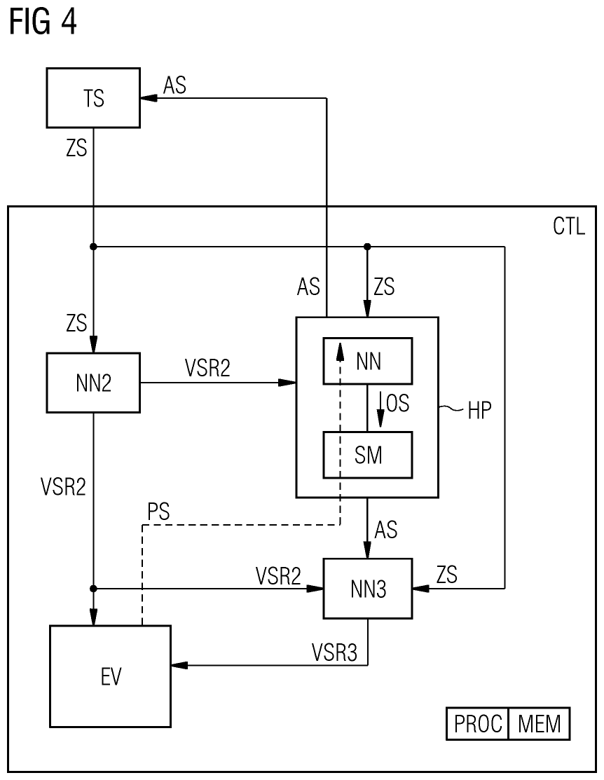

FIG. 4 shows a further exemplary embodiment of a control device according to embodiments of the invention in a training phase.

### DETAILED DESCRIPTION

FIG. 1 shows a gas turbine as a technical system TS with a control device CTL, by way of illustration. Alternatively, or additionally, the technical system TS can also comprise a wind turbine, an internal combustion engine, a production installation, a chemical, metallurgical or pharmaceutical manufacturing process, a robot, a motor-vehicle, a power transmission grid, a 3D printer or another machine, another device or another installation. The control device CTL is in the form of a machine controller.

The technical system TS is coupled to the control device CTL, which may be implemented as part of the technical system TS or totally or partially externally to the technical system TS. The control device CTL is shown externally to the technical system TS in FIGS. 1, 2 and 4 for reasons of clarity.

The control device CTL is used for controlling the technical system TS and has been trained for this purpose by a machine learning method. Control of the technical system TS will also be understood in this case to mean automatic control of the technical system TS and also output and use of control-relevant data or signals, i.e., data or signals that contribute to controlling the technical system TS.

Control-relevant data or signals of this type can comprise in particular control action signals, forecast data, monitoring signals, state signals and/or classification data, which can be used in particular for optimizing operation, monitoring or maintaining the technical system TS and/or for detecting wear or damage.

The technical system TS has sensors S that continuously measure one or more operating parameters of the technical system TS and output them as measured values. The measured values from the sensors S and any otherwise captured operating parameters of the technical system TS are transmitted from the technical system TS to the control device CTL as state signals ZS. The state signals ZS indicate, specify or encode in particular a present state or state range of the technical system TS.

The state signals ZS can comprise in particular physical, chemical, control-oriented, effect-oriented and/or design-dependent operating parameters, property data, capacity data, effect data, behavior signals, system data, control data, control action signals, sensor data, measured values, environment data, monitoring data, forecast data, analysis data and/or other data that are produced during operation of the technical system TS and/or that describe an operating state or a control action of the technical system TS. These may be for example data about temperature, pressure, emissions, vibrations, vibrational states or resource consumption of the technical system TS. Specifically in the case of a gas turbine, the operating signals BS can relate to a turbine capacity, a speed of rotation, vibration frequencies, vibration amplitudes, combustion dynamics, combustion alternating pressure amplitudes or nitrogen oxide concentrations.

The state signals ZS are used by the trained control device CTL to ascertain control actions that optimize a performance of the technical system TS and at the same time are admissible in the present state of the technical system TS. The performance to be optimized can relate in particular to a capacity, a yield, a velocity, an operating period, a precision, an error rate, an error scale, a resource requirement, an efficiency, a pollutant emission, a stability, a wear, a life and/or other target parameters of the technical system TS.

The ascertained, performance-optimizing and admissible control actions are prompted by the control device CTL by transmitting appropriate admissible control action signals AS to the technical system TS. The control action signals AS can adjust a gas feed, a gas distribution or an air feed, e.g., in the case of a gas turbine.

FIG. 2 shows a schematic representation of a learning-based control device CTL according to embodiments of the invention, a machine controller, in a training phase. The control device CTL is intended to be configured to control a technical system TS. Where the same or corresponding reference signs are used in the figures, these reference signs denote the same or corresponding entities.

In the present exemplary embodiment, the control device CTL is coupled to the technical system TS and to a database DB. The control device CTL comprises one or more processors PROC for carrying out the method according to embodiments of the invention and one or more memories MEM for storing process data.

As already described in connection with FIG. 1, state signals ZS that specify a respective present state of the technical system TS are transmitted from the technical system TS to the control device CTL. The latter uses the state signals ZS to ascertain control action signals AS that are admissible in the respective present state of the technical system TS. The admissible control action signals AS are transmitted from the control device CTL to the technical system TS in order to control the system in an optimized and safety-compliant fashion.

At least some of the state signals ZS can also be received or come from a technical system that is similar to the technical system TS, from a database containing stored state data of the technical system TS or of a technical system that is similar thereto and/or from a simulation of the technical system TS or of a technical system that is similar thereto.

To optimize the control, a behavior of the technical system TS that is induced by the admissible control action signals AS is detected and is encoded in the form of a behavior signal VS, which is transmitted from the technical system TS to the control device CTL. Alternatively, or additionally, a behavior signal VS may also be part of a state signal ZS and/or at least part of the behavior signal can be extracted from the state signal.

A behavior signal VS can specify in particular a capacity, a yield, a velocity, an operating period, a precision, an error rate, an error scale, a resource requirement, an efficiency, a pollutant emission, a stability, a wear, a life and/or other target parameters of the technical system TS. Specifically in the case of a gas turbine, a behavior signal VS can specify changes in combustion alternating pressure amplitudes, a speed or a temperature of the gas turbine. The behavior signals VS detected can be in particular state signals of the technical system TS that are relevant to a performance of the technical system TS.

In the present exemplary embodiment, the control device CTL comprises a trainable machine learning module NN, a safety module SIM coupled thereto, and a performance rater EV coupled to the safety module SM.

The state signals ZS are used as training data for the machine learning module NN and include in particular time series that specify states of the technical system TS over time.

The machine learning module NN in the present exemplary embodiment is configured as an artificial neural network, with a neural input layer N1 as input of the machine learning module NN and a neural output layer N2 as output of the machine learning module NN. The machine learning module NN can be implemented in particular as or by a TensorFlow graph.

Alternatively, or additionally, the machine learning module can use or implement a recurrent neural network, a convolutional neural network, a Bayesian neural network, an autoencoder, a deep learning architecture, a support vector machine, a data-driven trainable regression model, a k-nearest neighbors classifier, a physical model, a decision tree and/or a random forest. A large number of efficient implementations are available for the indicated variants and the training thereof.

A training will be understood in this case to mean generally an optimization of mapping of input signals to output signals. This mapping is optimized according to predefined, learned and/or learnable criteria during a training phase. The criteria used in this case can be e.g., a prediction error in the case of prediction models, a classification error in the case of classification models or a success or a performance of a control action in case of control models. The training allows for example networking structures of neurons of the neural network and/or weights of connections between the neurons to be adjusted, or optimized, in such a way that the predefined criteria are satisfied as well as possible. The training can therefore be regarded as an optimization problem. A large number of efficient optimization methods are available for such optimization problems in the field of machine learning. In particular, gradient descent methods, particle swarm optimizations and/or genetic optimization methods can be used.

To train the machine learning module NN, a respective state signal ZS is supplied to the input layer N1 of the machine learning module NN. The machine learning module NN then generates a resulting output signal OS from the respective state signal ZS, the output signal being supplied to the safety module SM. In addition, the state signal ZS that specifies a respective state of the technical system TS is also supplied to the safety module SM.

The safety module SM firstly serves the purpose of examining whether or not a supplied signal, here the output signal OS, is admissible as a control action signal in the respective state of the technical system TS. Secondly, the supplied signal is intended to be converted into a control action signal AS that is admissible in the respective state by the safety module SM. A conversion of the supplied signal is performed by the safety module SM only if the supplied signal is found to be inadmissible. Otherwise, the supplied signal is output unchanged as an admissible control action signal AS.

The criteria provided for admissibility of a control action signal in a respective state can be observance of predefined state-specific limit values or other state-specific constraints or a safety-compliant behavior during operation of the technical system TS.

The provided admissibility criteria are encoded or indicated by state-specific safety information SI. The safety information SI in the present exemplary embodiment is stored in the database DB, for example in the form of a configuration file, and is read in by the safety module SM. The safety information SI configures the safety module SM.

The safety information SI can comprise state-specific rules, conditions and/or limit values for control action signals or for a safety-compliant behavior of the technical system TS; for example, maximum or minimum values or speeds of change of operating or control parameters. As such, the safety module SM can examine whether or not a limit value for an operating parameter would be exceeded in the present state if a supplied control action signal were applied. If it would be exceeded, the supplied control action signal can be converted, otherwise not. In this way, explicit expert knowledge or domain knowledge can be taken into consideration in the training of the machine learning module NN.

Alternatively, or additionally, the examination for admissibility in a respective state can also be performed on the basis of the volume of training data available for this state. In addition, the examination for admissibility in a respective state can also be carried out on the basis of a forecast or modelling error of the machine learning module NN in this state.

Furthermore, the safety module SM configures a transformation function F implemented therein for converting supplied signals into admissible control action signals using the safety information SI. In the present exemplary embodiment, the transformation function F is implemented as a function of the state signal ZS, the supplied signal, here OS, and the safety information SI and returns a control action signal, here AS, that is admissible in the relevant state, according to AS=F(ZS, OS; SI).

As described above, the transformation function F can initially examine whether the supplied signal OS is admissible. If this is the case, the supplied signal OS is output unchanged as an admissible control action signal AS, otherwise a conversion is performed. The conversion can then involve signal components that exceed a limit value being limited, for example, or a default control action signal can be output.

For the present exemplary embodiment, it will be assumed that the transformation function F conveys distinguishable mapping from the supplied signal OS to the signal that is output AS.

The safety module SM comprises a sequence of multiple layers connected in series that are able to be implemented as or by a TensorFlow graph, for example. In the present exemplary embodiment, the safety module SM has an input layer S1 as input of the safety module SM and has an output layer S2 as output of the safety module SM. The safety module SM can be regarded in particular as a filter or modifier for control action signals.

The safety module SM is intended to be used to train the machine learning module NN, by using reinforcement learning, to output an output signal OS that, following possible conversion by the safety module SM, controls the technical system TS in a manner that optimizes the performance of said the system. In this respect, the output signal OS can be regarded as a raw control action signal to a certain degree.

During the training, the technical system TS is controlled by the control action signal AF that is output by the safety module SM. A behavior of the technical system TS that is induced by this control is encoded in the form of the behavior signal VS. The latter is transmitted to the control device CTL, where it is supplied to the performance rater EV.

The performance rater EV serves the purpose of ascertaining for a respective control action a performance of the behavior of the technical system TS that is triggered by this control action on the basis of the behavior signal VS. In this case, the performance can be defined as explained in connection with FIG. 1.

For this purpose, the behavior signal VS is evaluated by the performance rater EV, by a so-called reward function. The reward function here ascertains and quantifies the performance of a present system behavior as a reward. Such a reward function is often also referred to as a cost function, loss function, target function or value function.

Alternatively, or additionally, the performance can also be derived from a simulated or predicted behavior of the technical system TS. In addition, a behavior of the technical system TS can also be read in from a database, for example by a state-specific and control-action specific database query.

The performance rater EV ascertains a performance that is discounted into the future. This involves forming a weighted sum of future performance values using weighting factors that fall in the direction of the future.

Besides the behavior signal VS, the performance rater EV can also take into consideration an operating state, a present control action and/or one or more setpoint values for a system behavior during the evaluation.

As already indicated above, the measure used for the performance can be in particular a capacity, a yield, a velocity, an operating period, a precision, an error rate, an error scale, a resource requirement, an efficiency, a pollutant emission, a stability, a wear, a life and/or other target parameters of the technical system TS.

The ascertained performance is quantified by the performance rater EV in the form of a performance signal PS. The performance signal PS is intended to be used to train the machine learning module NN to optimize the performance. A multiplicity of machine learning methods, in particular reinforcement learning methods and backpropagation methods, are available for this purpose in principle. In the present case, an inherently known backpropagation method is matched in a particularly efficient manner to a training for the machine learning module NN coupled to the safety module SM.

For the purpose of the training, the performance signal PS is transmitted from the performance rater EV to the safety module SM, where it is supplied to the output layer S2. Insofar as the transformation function F conveys distinguishable mapping, the performance signal PS can be backpropagated from the output layer S2 to the input layer S1 by using known and efficient gradient-based backpropagation methods. The performance signal PS can be backpropagated as an error signal, with the specific feature that a greater performance corresponds to a smaller error. During the backpropagation by the safety module SM, the conversion behavior and examination behavior of the module are not changed, but rather only the backpropagated performance signal.

The resulting performance signal RPS backpropagated to the input layer S1 is then supplied to the output layer N2 of the machine learning module NN. The output layer N2 backpropagates the resulting performance signal RPS on to the input layer N1 by using known gradient-based backpropagation methods. In this case too, the resulting performance signal RPS can be backpropagated as an error signal, with the specific feature that a greater performance corresponds to a smaller error. The backpropagation is used to train the machine learning module NN by optimizing learning parameters in the course of the backpropagation, such as e.g., neural weights of the machine learning module NN, in respect of the training target of a maximum performance. Unlike in the case of the safety module SM, a conversion behavior of the machine learning module NN is thus changed by the backpropagation.

Insofar as the safety module SM and the machine learning module NN are implemented by TensorFlow graphs, the backpropagation can be carried out in a TensorFlow environment easily and as intended.

The training of the machine learning module NN configures the control device CTL. The series connection of the trained machine learning module NN and the downstream safety module SM can be regarded as a hybrid policy HP that, depending on the state signal ZS that is supplied to the hybrid policy HP, outputs only admissible and performance-optimizing control action signals AS. The control device CTL trained, or configured, in this way can then be used, as described in connection with FIG. 1, to control the technical system TS in an optimized and safety-compliant fashion.

FIG. 3 shows a conversion of a raw control action signal OS into an admissible control action signal AS by the safety module SM using two graphs.

In the top graph, a volume TD of training data available for a respective state ST is schematically plotted against the respective state ST. A respective state ST can be represented in this case in particular by a respective value of a state signal, for example a pollutant value or a speed value.

There are clearly only very few training data available in the right-hand state range. It thus cannot be expected that the machine learning module NN will output optimized or even just advantageous control action signals AS in this state range.

In the bottom graph, the output signal OS as a raw control action signal and the admissible control action signal AS resulting from the conversion of the output signal by the safety module SM are each plotted against the state ST. The output signal OS and the admissible control action signal AS tally in state ranges B1 and differ in a state range B2.

In the state range B2, the safety module SM has used the safety information SI to firstly detect that only relatively few training data are available. Secondly, it has been ascertained that unfiltered application of the output signal OS to the technical system TS would result in a critical or otherwise inadmissible system state being reached. As a result, the output signal OS is modified by the safety module SM in the state range B2 in order to obtain an admissible control action signal AS in this way. In the present case, the output signal OS is modified by a state-dependent shift of the signal values thereof.

In the state ranges B1, on the other hand, the output signal OS has been rated by the safety module SM as admissible and is consequently output unchanged as an admissible control action signal AS.

FIG. 4 shows a schematic representation of a further exemplary embodiment of a control device CTL according to embodiments of the invention in a training phase. The training is intended to configure the control device CTL to control the technical system TS. A hybrid policy HP is intended to be trained to use a state signal ZS of the technical system TS to generate a performance-optimizing and admissible control action signal AS for controlling the technical system TS. The hybrid policy HP comprises a machine learning module NN to be trained and a downstream safety module SM, which are implemented and act as described above. The training of the machine learning module NN in the specific interaction with the safety module SM is also performed as explained above.

To train the hybrid policy HP, the control device CTL receives state signals ZS of the technical system TS from the technical system TS as training data. In addition, a second machine learning module NN2 and a third machine learning module NN3 are used for this training.

The second machine learning module NN2 has been trained beforehand, by using standard supervised learning methods, to use a state signal ZS of the technical system TS to predict or reproduce a behavior of the technical system TS that would develop without a control action being applied at present. This training can be performed for example in such a way that output signals of the second machine learning module NN2 that are induced by state signals ZS are compared with actual behavior signals of the technical system TS that have been produced without a control action being applied at present. The second machine learning module NN2 can then be optimized in such a way that a disparity between the induced output signals and the actual behavior signals is minimized.

The trained second machine learning module NN2 can therefore use a state signal ZS to reproduce a behavior signal VSR2 of the technical system TS, as would be produced without a control action being applied at present, with a high level of accuracy.

The third machine learning module NN3 has been trained beforehand, by using standard supervised learning methods, to use a control action signal AS and a state signal ZS of the technical system TS to predict or reproduce a behavior of the technical system TS that is induced by a respective control action. This training can be performed for example in such a way that output signals of the third machine learning module NN3 that are induced by control action signals AS and state signals ZS are compared with actual control-action-induced behavior signals of the technical system TS. The third machine learning module NN3 can then be optimized in such a way that a disparity between the induced output signals and the actual control-action-induced behavior signals is minimized.

The trained third machine learning module NN3 can therefore use a control action signal AS and a state signal ZS to reproduce a control-action-induced behavior signal VSR3 of the technical system TS with a high level of accuracy. In an embodiment, the behavior signals VSR2 of the second machine learning module NN2 can additionally be used as input data during the training and during the application of the third machine learning module NN3. This generally increases a prediction accuracy of the third machine learning module NN3.

In the present exemplary embodiment, the training of the machine learning modules NN2 and NN3 is already complete when the machine learning module NN is trained.

Besides the machine learning modules NN, NN2 and NN3, the control device CTL furthermore comprises a performance rater EV that is coupled to the machine learning modules NN, NN2 and NN3 and is implemented and acts as described above. In addition, the second machine learning module NN2 is coupled to the machine learning modules NN and NN3 and the third machine learning module NN3 is coupled to the machine learning module NN.

The performance rater EV is used, as already indicated above, to ascertain for a respective control action a performance of the behavior of the technical system TS that is triggered by this control action on the basis of behavior signals. In the present exemplary embodiment, the performance is ascertained on the basis of predicted behavior signals VSR2 and VSR3. The performance is quantified by the performance rater EV in the form of a performance signal PS.

To train the machine learning module NN, the state signals ZS are supplied to the trained machine learning modules NN2 and NN3, to the machine learning module NN to be trained and to the safety module SM as input signals.

The state signals ZS are used by the trained second machine learning module NN2 to reproduce a behavior signal VSR2 of the technical system TS, as would be produced without a control action being applied at present. The reproduced behavior signal VSR2 is supplied by the second machine learning module NN2 to the machine learning module NN, to the third machine learning module NN3 and to the performance rater EV.

An output signal OS of the machine learning module NN that results from the state signals ZS and the reproduced behavior signals VSR2 is furthermore supplied to the safety module SM, which converts the output signal OS—as described above—into an admissible control action signal AS. The latter is supplied to the trained third machine learning module NN3 as an input signal. The admissible control action signal AS, the reproduced behavior signal VSR2 and the state signals ZS are used by the trained third machine learning module NN3 to reproduce a control-action-induced behavior signal VSR3 of the technical system TS, which the trained third machine learning module NN3 supplies to the performance rater EV.

The performance rater EV uses the reproduced behavior signal VSR3 to quantify a present performance of the technical system TS in light of the reproduced behavior signal VSR2. This results in a disparity between the control-action-induced behavior signal VSR3 and the behavior signal VSR2 being ascertained. This disparity can be used by the performance rater EV to rate how a system behavior when a control action is applied differs from the system behavior without this control action being applied. It is found that the performance rating can be significantly improved by this distinction in many cases.

The resulting performance signal PS that quantifies the performance is, as indicated by a dashed arrow in FIG. 4, returned to the hybrid policy HP, where, as explained above, it is backpropagated by the safety module SM and the machine learning module NN. The backpropagated performance signal PS is used to train the machine learning module NN to maximize the control action performance. A large number of known backpropagation methods and optimization methods can be used to maximize the control action performance, as repeatedly mentioned above.

Using not only the state signals ZS but also the reproduced behavior signal VSR2 to train the machine learning module NN allows the latter to be trained particularly effectively, since the machine learning module NN has specific information available about a system behavior without control actions.

The training of the machine learning module NN configures the control device CTL to control the technical system TS by the control action signal AS of the trained hybrid policy HP in both an admissible and a performance-optimizing fashion.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for configuring a control device for a technical system, wherein
a) reading in safety information about an admissibility of a control action signal, which safety information is specific to a state of the technical system, by a safety module;
b) supplying a state signal indicating a state of the technical system to a machine learning module and to the safety module;
c) supplying an output signal of the machine learning module to the safety module;
d) converting the output signal into an admissible control action signal by the safety module on a basis of the safety information depending on the state signal,
e) ascertaining a performance for control of the technical system by the admissible control action signal;
f) training the machine learning module to optimize the performance; and
g) controlling the technical system on a basis of an admissible control signal that is output by the safety module, using the control device configured on a basis of the trained machine learning module.

2. The method as claimed in claim 1, wherein a backpropagation method is used to train the machine learning module, the backpropagation method involving a performance signal that quantifies the performance being backpropagated from an output of the safety module to an input of the safety module and a resulting performance signal furthermore being backpropagated from an output of the machine learning module to an input of the machine learning module.

3. The method as claimed in claim 1, wherein the safety module uses the safety information to examine whether the output signal is admissible as a control action signal, and in that the output signal is converted into the admissible control action signal on the basis of the examination result.

4. The method as claimed in claim 3, wherein if the output signal is admissible as a control action signal, the output signal is output by the safety module as an admissible control action signal, and otherwise the output signal is converted into the admissible control action signal.

5. The method as claimed in claim 3, wherein the safety information indicates or encodes an admissible, state-specific default control action signal, and in that the output signal is converted into the admissible default control action signal on the basis of the examination result.

6. The method as claimed in claim 3, wherein a volume of training data available for a state specified by the state signal is ascertained for this state, and in that the examination for admissibility of the output signal is performed on the basis of the ascertained volume.

7. The method as claimed in claim 3, wherein a forecast error or modelling error of the machine learning module is ascertained for a state specified by the state signal, and in that the examination for admissibility of the output signal is performed on the basis of the ascertained forecast error or modelling error.

8. The method as claimed in claim 1, wherein the safety information configures, indicates or encodes a transformation function, in that the output signal and the state signal are supplied to the transformation function, and in that the output signal is converted into the admissible control action signal by the transformation function on the basis of the state signal.

9. The method as claimed in claim 1, wherein the technical system is controlled by the admissible control action signal, in that a behavior of the technical system controlled in this way is detected, and in that the performance is derived from the detected behavior.

10. The method as claimed in claim 1, wherein a behavior of the technical system controlled by the admissible control action signal is simulated, predicted and/or read in from a database, and in that the performance is derived from the simulated, predicted and/or read-in behavior.

11. A control device for controlling a technical system, configured to carry out a method as claimed in claim 1.

12. A computer program product, comprising a computer readable hardware storage device having computer readable program code stored therein, said program code executable by a processor of a computer system to implement the method as claimed in claim 1.

13. A computer-readable storage medium having a computer program product as claimed in claim 12.
